(19) United States
(12) Patent Application Publication
(10) Pub. No.: US 2022/0122381 A1
(43) Pub. Date: Apr. 21, 2022

(54) FACE TO VOICE BASED ANALYSIS

(71) Applicant: Cortica Ltd., Tel Aviv (IL)

(72) Inventor: Karina Odinaev, Tel Aviv (IL)

(73) Assignee: Cortica Ltd., Tel Aviv (IL)

(21) Appl. No.: 17/443,641

(22) Filed: Jul. 27, 2021

Related U.S. Application Data
(60) Provisional application No. 63/057,261, filed on Jul. 27, 2020.

(51) Int. Cl. G06V 40/70; G06V 40/16; G10L 17/18; G06V 10/762; G06V 40/50; G06V 10/82

(52) U.S. Cl. CPC G06V 40/70; G06V 40/168; G06V 10/82; G06V 10/762; G06V 40/50; G10L 17/18

(57) ABSTRACT

A method that includes (a) receiving media units that include face images and voice information, (b) generate face image signatures (for the face images) by a neural network (NN), (c) cluster the face image signatures to provide clusters, (d) generating voice signatures to the voice information, and (d) processing voice signatures that are associated with face image signatures of the same cluster and reaching a conclusion regarding these voice signatures.

### BACKGROUND

There is a growing need to obtain information regarding persons based on partial inputs.

### DESCRIPTION OF EXAMPLE EMBODIMENTS

The specification and/or drawings may refer to an image. An image is an example of sensed information unit. Any reference to an image may be applied mutatis mutandis to a sensed information unit. The sensed information unit may be applied mutatis mutandis to a natural signal such as but not limited to signal generated by nature, signal representing human behavior, signal representing operations related to the stock market, a medical signal, and the like. The sensed information unit may be sensed by one or more sensors of at least one type—such as a visual light camera, or a sensor that may sense infrared, radar imagery, ultrasound, electro-optics, radiography, LIDAR (light detection and ranging), a non-image based sensor (accelerometers, speedometer, heat sensor, barometer) etc.

The sensed information unit may be sensed by one or more sensors of one or more types. The one or more sensors may belong to the same device or system—or may belong to different devices of systems.

The sensed information may be processed by a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

There may be provided a neural network (NN)—(being a convolution neural network (CNN) or another neural network (ANN).

There may be provided a method that may include receiving media units that include face images (a face image includes, at least, visual information of a face of a person) and voice information (such as voice recordings) of the persons. For each person there is provide a face image and a voice recording.

The method may include feeding the face images to a NN—generate face image signatures (for the face images) by the NN, and cluster the face image signatures to provide clusters. The clusters may be further divided to sub-clusters. Metadata may be added to clusters and/or sub-clusters of any level.

Voice signatures may be generated to the voice information. The voice signatures may include information about one or multiple (or even all) of the following voice features—phonation, pitch, loudness, rate, the way the words are spoken, accent, different words frequencies, and the like.

The voice signatures may be generated by the NN that generated the face image signatures, by another NN by a machine learning process that does not use the NN that generated the face image signatures, or without using any NN.

The method may proceed by processing voice signatures that are associated with face image signatures of the same cluster and try to reach a conclusion regarding these voice signatures—for example whether they share a common features, what is the relationship between the signatures and the like.

The voice signatures related to multiple clusters may be processed to provide conclusions.

For example—a cluster that include face image signatures of old women with white ethnicity cluster—may be expected to have something in common in their voice (even human can recognize that an old person is speaking). Yet for another example—people with a certain structure of the nose—will have something in common in their voice.

Features that eventually cannot be predicted by voice—e.g. forehead, can be reconstructed based on other faces statistics from the same cluster (for example, people that have a certain age, ethnicity, structure of mouth, nose, that speak in a certain manner—the method may take the ones that do fit, and see if there are any statistically prominent features that predict the other parts).

There may be provided a method that will cluster the voice signatures and then find process face image signatures that are associated with voice signatures of the same cluster and try to reach a conclusion regarding these face image signatures.

It is appreciated that software components of the embodiments of the disclosure may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the disclosure. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub combination. It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method as substantially illustrated in the specification.

2. A non-transitory computer readable medium that stores instructions as substantially illustrated in the specification.

3. A system as substantially illustrated in the specification.
